(19) United States
(12) Patent Application Publication
(10) Pub. No.: US 2002/0099629 A1
(43) Pub. Date: Jul. 25, 2002

(54) Scheme for presenting recommended items through network using client preference estimating factor information

(76) Inventors: Motoi Sato, Tokyo (JP); Takeshi Motohashi, Tokyo (JP); Yusuke Ichikawa, Yokohama-ahi (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/053,788

(22) Filed: Jan. 18, 2002

(30) Foreign Application Priority Data
Jan. 19, 2001 (JP) P2001-011349

(51) Int. Cl. G06F 17/60

(52) U.S. Cl. 705/27

(57) ABSTRACT

In a recommended item presentation server, client identifier associated client preference estimating factor information of a plurality of clients is obtained, and when a recommended item presentation request and a client preference estimating factor information of one client is received from an item provider server for providing items to a plurality of clients through a network, where the client preference estimating factor information indicates a preference of the one client, without identifying the one client, a recommended item list is produced according to the client identifier associated client preference estimating factor information and the client preference estimating factor information and transmitted to the item provider server.

### BACKGROUND OF THE INVENTION

1. Field of the Invention

The present invention relates to a scheme for presenting recommended items to a client through a network such as the Internet.

2. Description of the Related Art

In a conventional recommended item presentation server for presenting recommended items, a client identifier associated client preference estimating factor information list of all the clients who accessed an item provider server or of sufficiently many clients for analyzing/estimating preferences is provided in advance from the item provider server. Then, the conventional recommended item presentation server has provided a service in which, when a recommended item presentation request and a client identifier are received from the item provider server, the preference of the client of the received client identifier is analyzed/estimated according to the client identifier associated client preference estimating factor information list provided from the item provider server, and a list of items that are expected to be of interest to this client is sent to the item provider server.

FIG. 14 shows a configuration of a conventional recommended item providing system, and FIG. 15 shows the processing procedure of the conventional recommended item providing system.

The conventional recommended item presentation system of FIG. 14 comprises an item provider server 62 for acquiring a client preference estimating factor information of a client 63 and a recommended item presentation server 61 for presenting recommended items.

Next, the operation of this conventional recommended item presentation system will be described with reference to FIG. 15.

1. Acquisition of client identifier associated client preference estimating factor information list:

(1) The client 63 transmits the client preference estimating factor information to the item provider server 62 (step 71);

The item provider server 62 which is a Web page search site, for example, acquires the access log (formed by a list of a client identifier, an item identifier and access date and time) of the client as the client preference estimating factor information.

This client identifier needs to be a client identifier that is unique over a plurality of item provider servers in order to provide services by identifying the same client at the plurality of item provider servers 62.

(2) The item provider server 62 transmits the client identifier associated client preference estimating factor information list to the recommended item presentation server 61 (step 72);

The item provider server 62 gathers the client preference estimating factor information collected from each client and regularly sends them as the client identifier associated client preference estimating factor information list to the recommended item presentation server 61/ Here, the client identifier associated client preference estimating factor information list can be given by a map that indicates the number of accesses (viewings/purchases) for each client identifier and item identifier pair, for example.

(3) The recommended item presentation server 61 processes the client identifier associated client preference estimating factor information list (step 73);

The recommended item presentation server 61 processes the received client identifier associated client preference estimating factor information list in order to be able to make a response to the recommended item presentation request from a client. The result of this processing is a list in which the item identifiers of items accessed by a client of each client identifier are arranged in an order of the number of accesses and a list in which the client identifiers of other clients who are accessing an item of each item identifier are arranged in an order of the number of accesses, for example.

2. Acquisition of the recommended item presentation is request:

(4) The client 63 transmits the recommended item presentation request to the item provider server 62 (step 74);

The client 63 transmits the recommended item presentation request along with the client identifier to the item provider server 62.

(5) The item provider server 62 transmits the recommended item presentation request to the recommended item presentation server 61 (step 75);

The item provider server 62 transmits the recommended item presentation request along with the client identifier to the recommended item presentation server 61.

(6) The recommended item presentation server 61 transmits the recommended item list to the item provider server 62 (step 76);

The recommended item presentation server 61 produces a list of item identifiers of the recommended items according to the client identifier received at (4), and sends it as the recommended item list along with the client identifier to the item provider server 62. In this transmission of the recommended item list, the fee such as a monthly fixed rate fee or a meter rate fee according to an amount of information is paid from the item provider server 62 to the company operating the recommended item presentation server 61.

(7) The item provider server 62 transmits the recommended item list to the client 63 (step 77);

The item provider server 62 transmits the recommended item list received at (6) to the client who is uniquely identified by the client identifier.

In the conventional recommended item presentation system described above, the client identifier associated client preference estimating factor information list of clients (all or sufficiently many for analyzing/estimating preferences) who are accessing each item provider server is often regarded as a valuable know-how by many item provider servers, so that it is difficult to acquire the client identifier associated client preference estimating factor information list from the item provider servers in many cases.

Moreover, the recommended item presentation request is to be made according to the client identifier, so that in the case of providing the recommended item presentation services at a plurality of item provider server, there is a problem that it is necessary to assign a client identifier which is unique and common to all the servers in order to identify the client over the entire system.

### BRIEF SUMMARY OF THE INVENTION

It is therefore an object of the present invention to provide a recommended item presentation scheme capable of realizing the recommended item presentation without a need for acquiring the client identifier associated client preference estimating factor information list from each item provider server that wishes to utilize the recommended item presentation service or a need for assigning a client identifier that is unique and common over a plurality of item provider servers.

According to one aspect of the present invention there is provided a recommended item presentation method, comprising the steps of: (a) obtaining client identifier associated client preference estimating factor information of a plurality of clients which is information according to which a preference of each client is to be estimated; and (b) receiving a recommended item presentation request and a client preference estimating factor information of one client from an item provider server for providing items to a plurality of clients through a network, where the client preference estimating factor information indicates a preference of the one client, without identifying the one client, producing a recommended item list according to the client identifier associated client preference estimating factor information and the client preference estimating factor information, and transmitting the recommended item list to the item provider server.

According to another aspect of the present invention there is provided a recommended item presentation server, comprising: a client preference estimating factor information processing unit configured to obtain client identifier associated client preference estimating factor information of a plurality of clients which is information according to which a preference of each client is to be estimated; and a recommended item presentation unit configured to receive a recommended item presentation request and a client preference estimating factor information of one client from an item provider server for providing items to a plurality of clients through a network, where the client preference estimating factor information indicates a preference of the one client, without identifying the one client, produce a recommended item list according to the client identifier associated client preference estimating factor information and the client preference estimating factor information, and transmit the recommended item list to the item provider server.

According to another aspect of the present invention there is provided a computer usable medium having computer readable program codes embodied therein for causing a computer to function as a recommended item presentation server, the computer readable program codes include: a first computer readable program code for causing said computer to obtain client identifier associated client preference estimating factor information of a plurality of clients which is information according to which a preference of each client is to be estimated; and a second computer readable program code for causing said computer to receive a recommended item presentation request and a client preference estimating factor information of one client from an item provider server for providing items to a plurality of clients through a network, where the client preference estimating factor information indicates a preference of the one client, without identifying the one client, produce a recommended item list according to the client identifier associated client preference estimating factor information and the client preference estimating factor information, and transmit the recommended item list to the item provider server.

According to another aspect of the present invention there is provided a method for providing a recommended item presentation service from a recommended item presentation server associated with one item provider server to a plurality of item provider servers for providing items to a plurality of clients through a network, comprising the steps of: (a) obtaining client identifier associated client preference estimating factor information of a plurality of clients which is information according to which a preference of each client is to be estimated, at the recommended item presentation server; and (b) upon receiving a recommended item presentation request and a client preference estimating factor information of one client from one of the plurality of item provider servers, where the client preference estimating factor information indicates a preference of the one client, without identifying the one client, producing a recommended item list according to the client identifier associated client preference estimating factor information and the client preference estimating factor information and transmitting the recommended item list to the one of the plurality of item provider servers at the recommended item presentation server.

Other features and advantages of the present invention will become apparent from the following description taken in conjunction with the accompanying drawings.

### BRIEF DESCRIPTION OF THE DRAWINGS

FIG. 1 is a block diagram showing an exemplary configuration of a recommended item presentation system according to one embodiment of the present invention.

FIG. 2 is a flow chart for a processing to acquire a client identifier associated client preference estimating factor information list in the recommended item presentation system of FIG. 1.

FIGS. 3A, 3B and 3C are diagrams showing exemplary forms of a client preference estimating factor information that can be used in the recommended item presentation system of FIG. 1.

FIG. 4 is a diagram showing an exemplary form of a client identifier associated client preference estimating factor information list that can be used in the recommended item presentation system of FIG. 1.

FIG. 5 is a diagram showing one exemplary form of a client preference estimating factor information map that can be used in the recommended item presentation system of FIG. 1.

FIG. 6 is a diagram showing another exemplary form of a client preference estimating factor information map that can be used in the recommended item presentation system of FIG. 1.

FIG. 7 is a flow chart for a processing to acquire a recommended item presentation request in the recommended item presentation system of FIG. 1.

FIG. 8 is a flow chart for a recommended item presentation processing in the recommended item presentation system of FIG. 1.

FIG. 9 is a block diagram showing a modified configuration of a recommended item presentation system according to one embodiment of the present invention.

FIG. 10 is a block diagram showing an exemplary configuration of a recommended item presentation system of the present invention applied to a recommended goods (advertisement) presentation.

FIG. 11 is a flow chart for a recommended goods (advertisement) presentation processing in the recommended item presentation system of FIG. 10.

FIG. 12 is a diagram for explaining a method for producing a recommended item list that can be used in a recommended item presentation system of the present invention.

FIG. 13 is a block diagram showing an exemplary configuration of a computer system for implementing a recommended item presentation server in the recommended item presentation system of FIG. 1.

FIG. 14 is a block diagram showing an exemplary configuration of a conventional recommended item presentation system.

FIG. 15 is a flow chart for operations of the conventional recommended item presentation system of FIG. 14.

### DETAILED DESCRIPTION OF THE INVENTION

First, the major features of the present invention will be briefly summarized.

In the present invention, the recommended item presentation service is provided to a plurality of item provider servers according to the client identifier associated client preference estimating factor information list provided from a third party company or the like (a client identifier associated client preference estimating factor information list providing server), such that the recommended item presentation service can be provided to clients utilizing the item provider servers without acquiring the client identifier associated client preference estimating factor information list from each item provider server that utilizes the recommended item presentation service.

Also, the client identifier is not required as information necessary in carrying out the recommended item presentation, so that there is no need to assign a client identifier for identifying the client which is unique over a plurality of item providing servers. Moreover, there is no possibility of leaking the client preference estimating factor information which is a privacy information of the client in correspondence with the client, so that it is possible to protect the privacy.

The present invention is particularly effective in the application service provider business for providing the recommended item presentation service.

The item provider servers that are targets of the present invention include not only those servers that are providing services on the Internet but also those servers to be utilized in the network service capable of exchanging information (items) bidirectionally such as a digital TV and an IT home electronics network.

Now, the definitions of some terms to be used in the following description will be described.

Items: Advertisements, information, titles and abstracts of CDs/books/movies, songs (music data), TV programs, etc.

Clients: Users using the item providing server and the recommended item presentation device. Depending on the method for assigning the client identifiers, this term may indicate client terminals used by the clients.

Item provider: A company that operates a server for providing items to a plurality of clients. A company that operates an EC site for presenting/selling items such as CDs/Books, etc., a search/directory site for presenting/searching items such as Web contents, information, etc., or an electronic mall site for presenting/selling items such as goods by uniting a plurality of EC sites. Note that a server/device that is operated by such a company will be referred to as an item provider server.

Client preference estimating factor information: An information on a basis of which the client preference is to be estimated. In the present invention, it is given by a log of accesses with respect to items by the client, a list of interested items entered by the client, a list of ratings on interested items entered by the client, etc. For example, it can be a list of “item identifiers and access dates and times” for each client, a list of “item identifiers and ratings” for each client, or a list of “item identifiers” for each client.

Client identifier associated client preference estimating factor information list: The client preference estimating factor information of the clients collected by a server for collecting the client preference estimating factor information, in a form of a list for each one of a plurality of client identifiers that are unique within that server.

The recommended item presentation: An operation of a server that carries out the service for providing items, in which the client preference is estimated by utilizing the client preference estimating factor information and a list of items that are expected to be of interest of the client is presented.

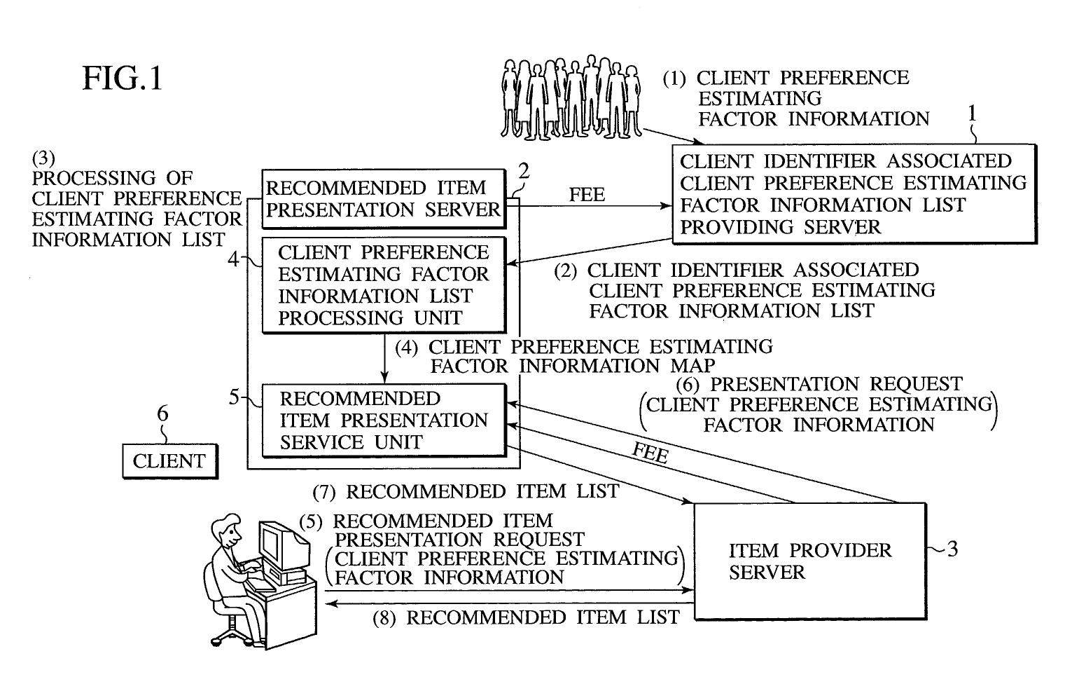

Referring now to FIG. 1 to FIG. 13, one embodiment of a scheme for presenting recommended items to a client through a network according to the present invention will be described in detail.

FIG. 1 shows a configuration of a recommended item presentation system according to one embodiment of the present invention.

This recommended item presentation system comprises a client identifier associated client preference estimating factor information list providing server 1, a recommended item presentation server 2, and an item provider server 3.

The client identifier associated client preference estimating factor information list providing server 1 collects and gathers the client preference estimating factor information from the clients, transmits the client identifier associated client preference estimating factor information list to the recommended item presentation server 2, and receives the payment of the fee from the recommended item presentation server 2 with respect to this transmission.

The recommended item presentation server 2 has a client preference estimating factor information list processing unit 4 and a recommended item presentation service unit 5.

The client preference estimating factor information list processing unit 4 receives and gathers the client identifier associated client preference estimating factor information list from the client identifier associated client preference estimating factor information list providing server 1, generates a client preference estimating factor information map, transmits the client preference estimating factor information map to the recommended item presentation service unit 5, and pays the fee with respect to the transmission of the client identifier associated client preference estimating factor information list by the client identifier associated client preference estimating factor information list providing server 1.

The recommended item presentation service unit 5 receives the client preference estimating factor information map from the client preference estimating factor information list processing unit 4, and when a recommended item presentation request is received along with the client preference estimating factor information from the item provider server 3, the recommended item presentation service unit 5 generates a list of recommended items according to the client preference estimating factor information map and the received client preference estimating factor information, and transmits this list as a recommended item list to the item provider server 3. A fee will be paid from the item provider server 3 to the recommended item presentation server 2 with respect to the transmission of the recommended item list.

The item provider server 3 receives the recommended item presentation request from a client 6, transmits it to the recommended item presentation service unit 5 of the recommended item presentation server 2, receives the recommended item list transmitted from the recommended item presentation service unit 5, and transmits the recommended item list to the client 6. Note that a fee will be paid with respect to the transmission of the recommended item list from the recommended item presentation server 2.

Next, the operation of the recommended item presentation system according to this embodiment will be described.

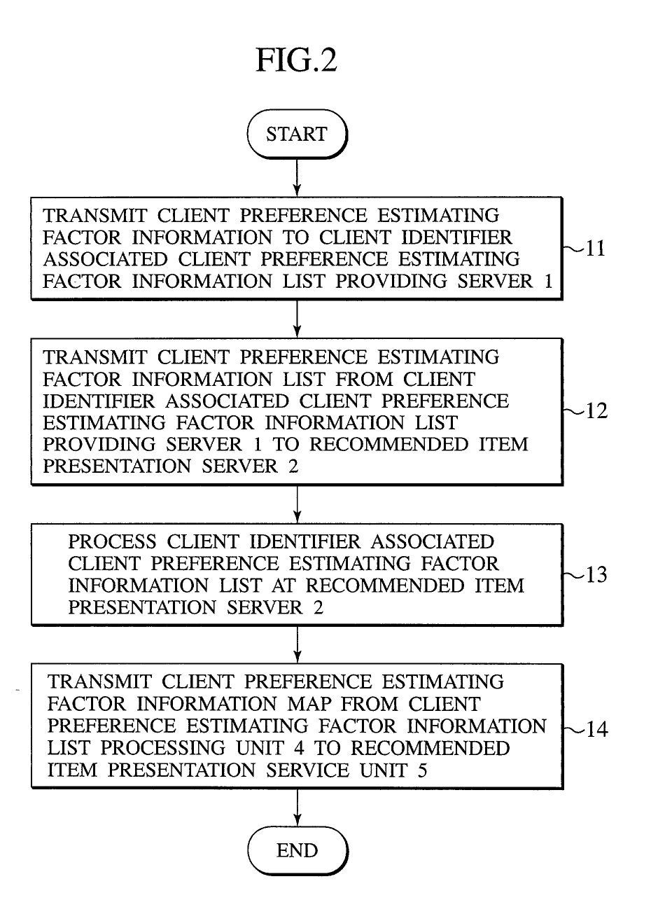

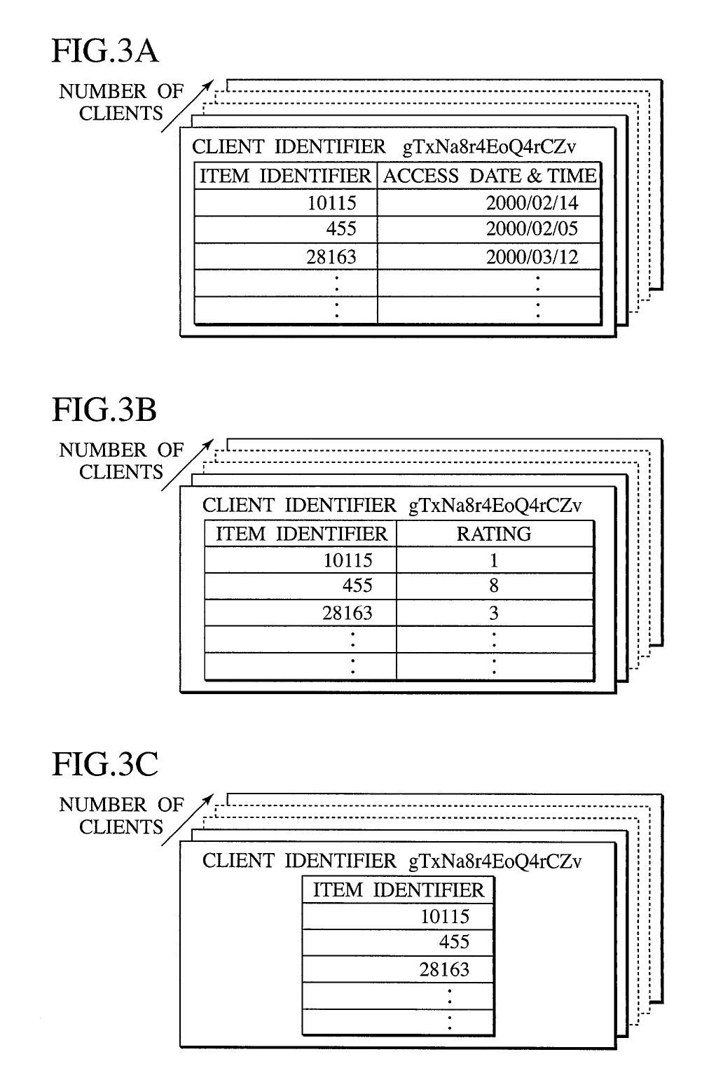

1. Acquisition of client identifier associated client preference estimating factor information list (FIG. 2 and FIGS. 3A, 3B and 3C):

(1) The client transmits the client preference estimating factor information to the client identifier associated client preference estimating factor information list providing server 1 (step 11);

The client identifier associated client preference estimating factor information list providing server 1 acquires an access log (a list of item identifiers and dates and times of accesses (viewings/purchases of items of the item provider server 3) for each client identifier) of the client 6 as shown in FIG. 3A in the case where the item provider server 3 is a Web page search site or the like, or acquires numerical values indicating levels of interests of the client with respect to books, CDs, etc. which are entered by the client (a list of item identifiers (goods identifiers) and ratings of the items for each client identifier) as shown in FIG. 3B or a list of goods such as books, CDs, etc. that the client is interested in which are entered by the client (a list of item identifiers (goods identifiers) for each client identifier) as shown in FIG. 3C in the case where the item provider server 3 is an EC site or the like for selling books, CDs, etc.

Note that the client identifier used here only needs to be capable of identifying each client uniquely within the client identifier associated client preference estimating factor information list providing server 1, and there is no need to use a client identifier that is unique over a plurality of item provider servers.

(2) The client identifier associated client preference estimating factor information list providing server 1 transmits the client identifier associated client preference estimating factor information list to (the client preference estimating factor information list processing unit 4 of) the recommended item presentation server 2 (step 12);

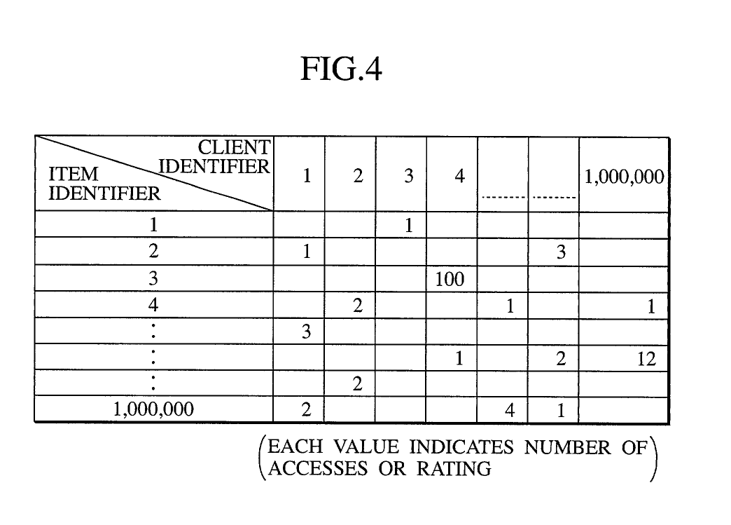

The client identifier associated client preference estimating factor information list providing server 1 gathers the client preference estimating factor information collected from clients, and transmits the client identifier associated client preference estimating factor information list in a map format as shown in FIG. 4 to (the client preference estimating factor information list processing unit 4 of) the recommended item presentation server 2.

(3) The recommended item presentation server 2 processes the client identifier associated client preference estimating factor information list (at the client preference estimating factor information list processing unit 4) (step 13);

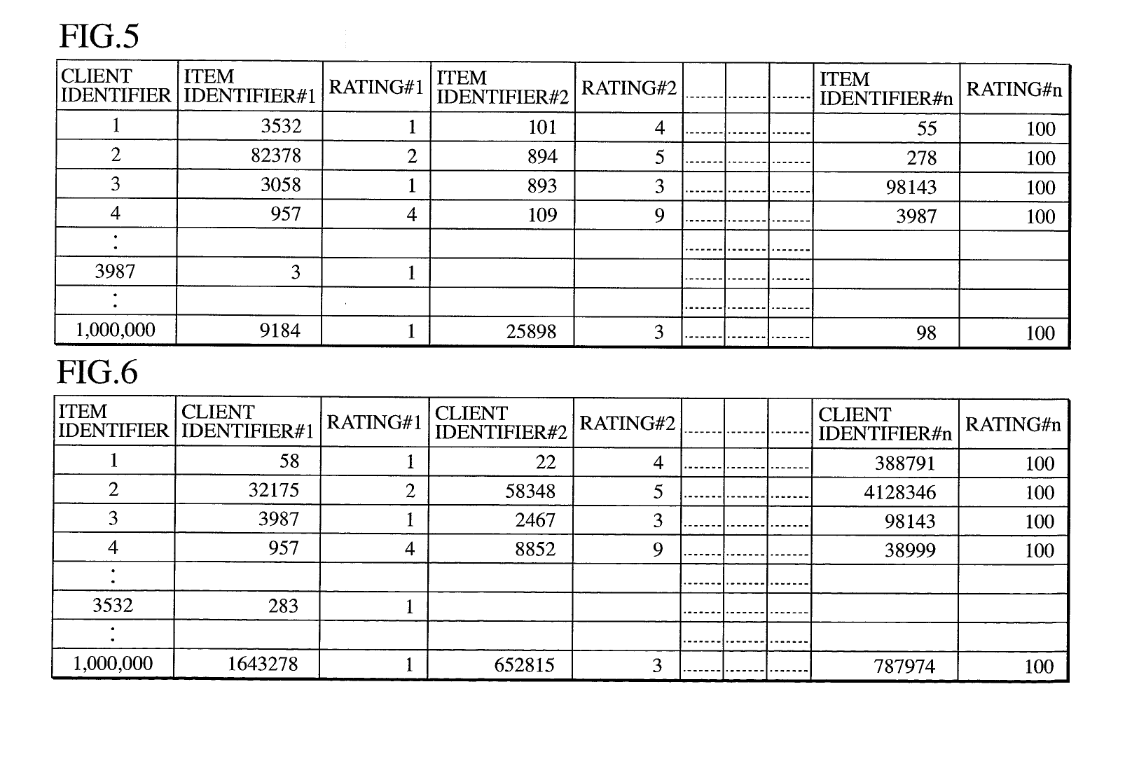

The recommended item presentation server 2 processes the received client identifier associated client preference estimating factor information list (at the client preference estimating factor information list processing unit 4) in order to be able to make a response to the recommended item presentation request from the client 6, and generates the client preference estimating factor information map. This client preference estimating factor information map is a list of the item identifiers of items accessed by the client 6 and their ratings for each client identifier as shown in FIG. 5, or a list of the client identifiers of the clients who are accessing an item and their ratings for each client identifier as shown in FIG. 6, or a list of correlation values of correlated items obtained by analyzing the client preference estimating factor information, for example. It is also possible to omit the ratings in FIG. 5 or FIG. 6.

Note that the client identifier used here only needs to be capable of identifying each client uniquely within the recommended item presentation server 2, and there is no need to use a client identifier that is unique over a plurality of item provider servers, and there is no need to use the client identifier transmitted from the client identifier associated client preference estimating factor information list providing server 1.

The recommended item presentation server 2 pays the fee such as a monthly fixed rate fee or a meter rate fee according to an amount of information, to a company operating the client identifier associated client preference estimating factor information list providing server 1, with respect to the transmission of the client identifier associated client preference estimating factor information list by the client identifier associated client preference estimating factor information list providing server 1.

(4) The client preference estimating factor information list processing unit 4 transmits the client preference estimating factor information map to the recommended item presentation service unit 5 (step 14);

The client preference estimating factor information list processing unit 4 transmits the client preference estimating factor information map generated at (3) to the recommended item presentation service unit 5.

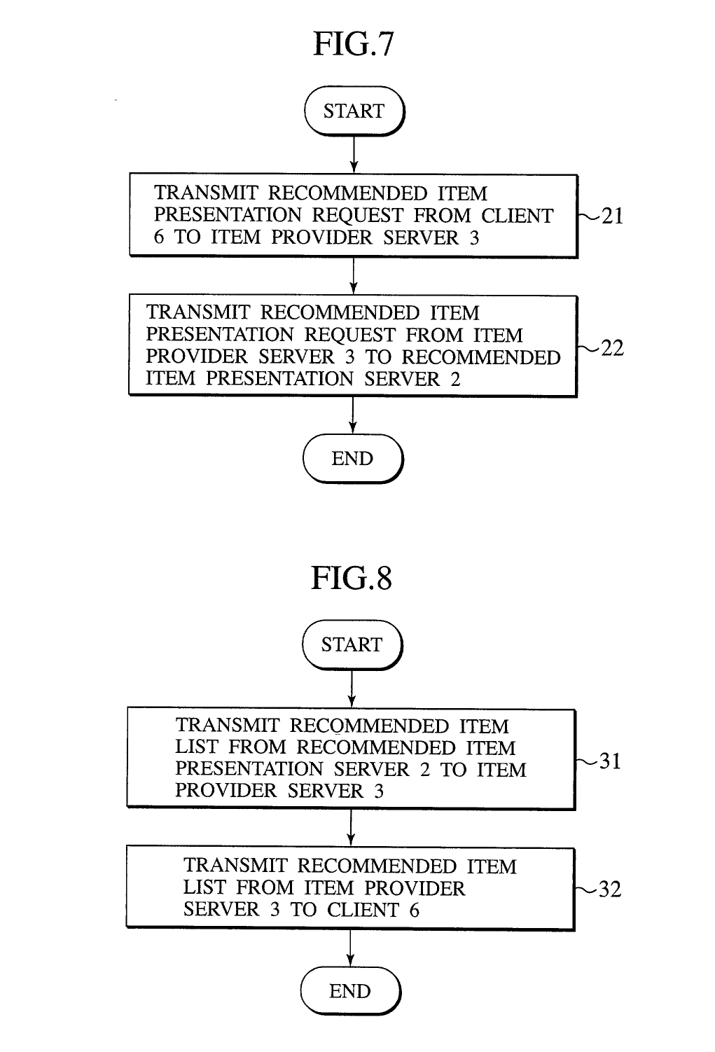

2. Acquisition of the recommended item presentation request (FIG. 7:

(5) The client 6 transmits the recommended item presentation request to the item provider server 3 (step 21);

The client 6 transmits the recommended item presentation request along with a request identifier and the client preference estimating factor information to the item provider server 3. The client preference estimating factor information is a list of “item identifiers and access dates and times” for each client, a list of “item identifiers and ratings” for each client, or a list of “item identifiers” for each client, for example. Here there is no need to use information such as the client identifier for uniquely identifying the client.

(6) The item provider server 3 transmits the recommended item presentation request to (the recommended item presentation service unit 5 of) the recommended item presentation server 2 (step 22);

The item provider server 3 transmits the recommended item presentation request along with the request identifier and the client preference estimating factor information to (the recommended item presentation service unit 5 of) the recommended item presentation server 2. Here, there is no need to use information such as the client identifier for uniquely identifying the client.

3. Presentation of recommended items (FIG. 8):

(7) The recommended item presentation server 2 transmits the recommended item list to the item provider server 3 (from the recommended item presentation service unit 5) (step 31);

The recommended item presentation server 2 produces a list of recommended items according to the client preference estimating factor information map received at (4) and the client preference estimating factor information received at (6), and transmits it as the recommended item list along with the request identifier to the item provider server 3 (at the recommended item presentation service unit 5). In this transmission of the recommended item list, the fee such as a monthly fixed rate fee or a meter rate fee according to an amount of information is paid from the item provider server 3 to the company operating the recommended item presentation server 2.

(8) The item provider server 3 transmits the recommended item list to the client 6 (step 32);

The item provider server 3 transmits the recommended item list received at (7) to the client from which the recommended item presentation request is received at (5).

As a modification of the embodiment described above, it is possible to provide the recommended item presentation service unit 5 in the item provider server 3 rather than in the recommended item presentation server 2 and connect the client preference estimating factor information list processing unit 4 and the recommended item presentation service unit 5 through a network.

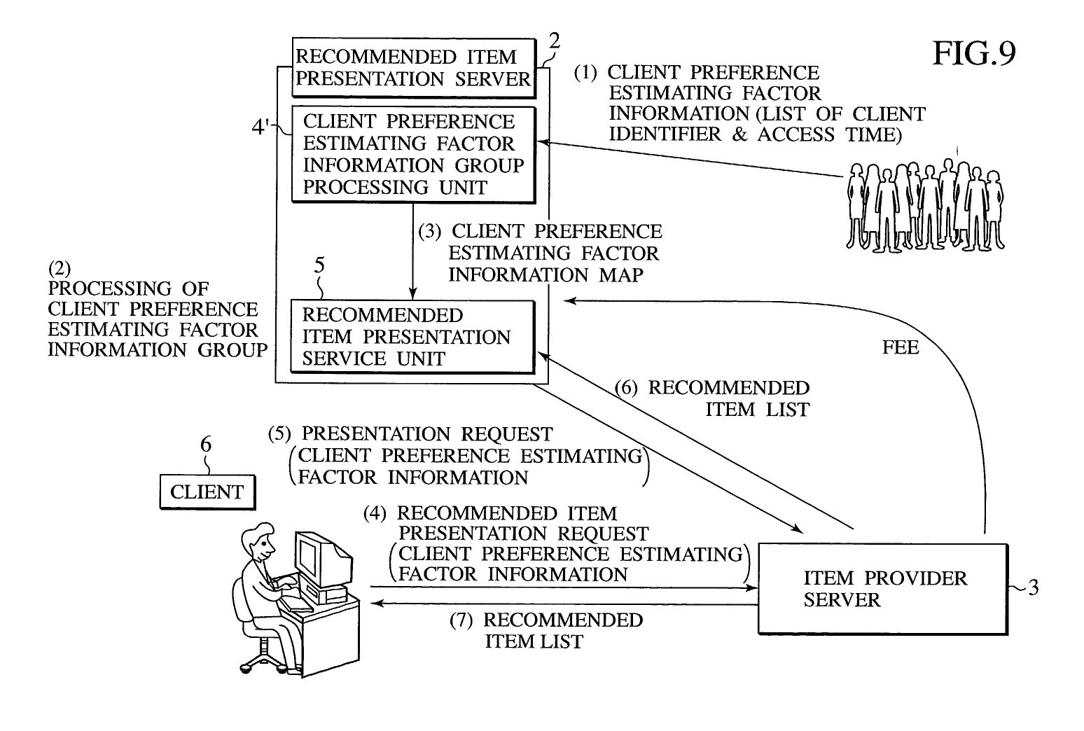

As another modification of the embodiment described above, as shown in FIG. 9, it is also possible to omit the client identifier associated client preference estimating factor information list providing server 1 and replace the client preference estimating factor information list processing unit 4 by a client preference estimating factor information group processing unit 4′ for directly collecting the client preference estimating factor information from the clients at the recommended item presentation server 2.

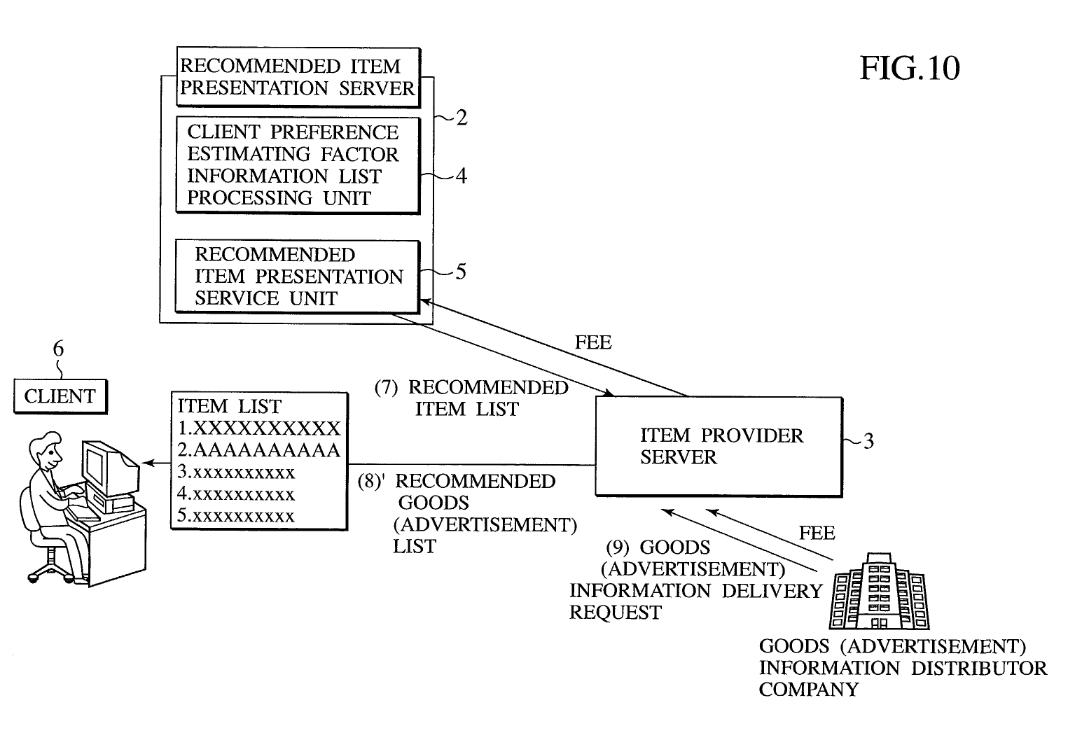

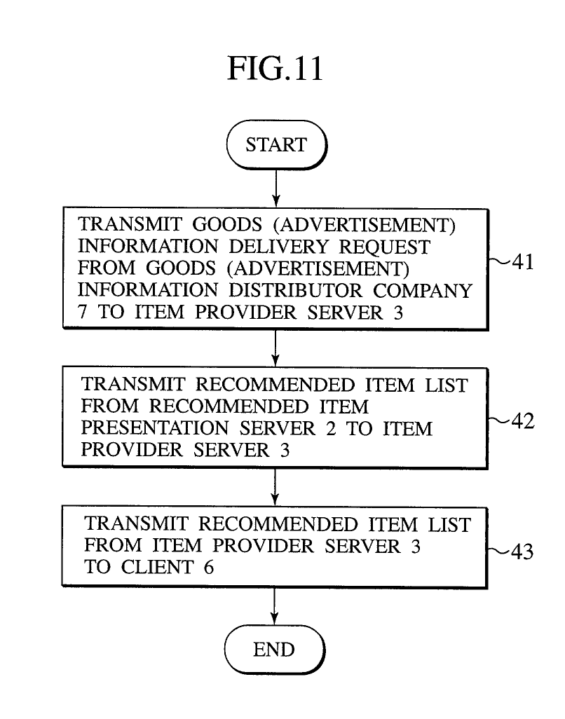

FIG. 10 shows the case of applying the recommended item presentation system of the present invention to a recommended goods (advertisement) presentation such as an advertisement display, and FIG. 11 shows the operation in this case which is as follows.

(9) A goods (advertisement) information delivery request from a goods (advertisement) information distributor company 7 to the item provider server 3 (step 41);

The goods (advertisement) information distributor company 7 transmits the goods (advertisement) information delivery request along with the goods (advertisement) information that is desired to be delivered, to the item provider server 3.

In carrying out the delivery of the goods (advertisement) information, the fee such as a monthly fixed rate fee, a meter rate fee according to the amount of display of the goods (advertisement) information, a meter rate fee according to the number of viewings of the goods (advertisement) information, or a meter rate fee according to the number of the amount of purchases of the goods is to be paid to the company operating the item provider server 3 by the goods (advertisement) information distributor company 7.

(7) The recommended item presentation server 2 transmits the recommended item list to the item provider server 3 (from the recommended item presentation service unit 5) (step 42);

The recommended item presentation server 2 produces a list of recommended items according to the client preference estimating factor information map received at (4) and the client preference estimating factor information received at (6), and transmits it as the recommended item list along with the request identifier to the item provider server 3 (at the recommended item presentation service unit 5). In this transmission of the recommended item list, the fee such as a monthly fixed rate fee or a meter rate fee according to an amount of information is paid from the item provider server 3 to the company operating the recommended item presentation server 2.

(8)′ The item provider server 3 transmits the recommended item list to the client 6 (step 43);

The item provider server 3 extracts the goods (advertisement) information received at (9) from the recommended item list received at (7), and transmits the extracted goods (advertisement) information to the client from which the recommended item presentation request is received at (5).

As a modification of this case, it is also possible for the recommended item presentation server 2 to identifies/extracts the goods (advertisement) information recorded at the item provider server 3 and delivers a list of the recommended goods (advertisement) information to the item provider server 3.

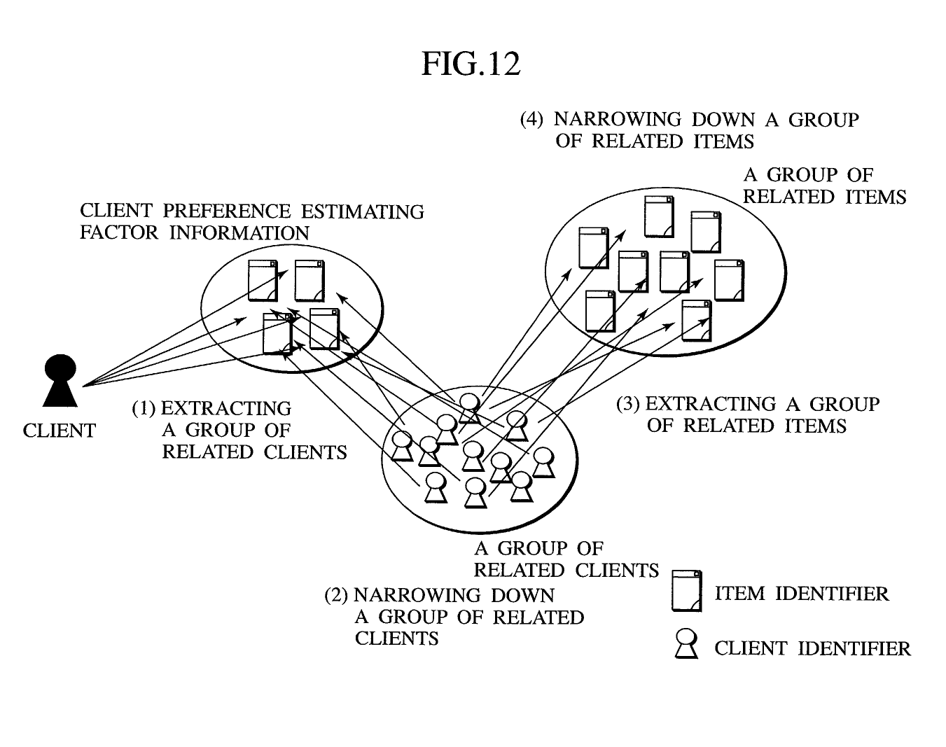

Next, the method for producing the recommended item list will be described with reference to FIG. 12.

As an analysis method to be used in realizing the transmission of the recommended item list from the recommended item presentation server 2 to the item provider server 3 of the above described (7), it is possible to utilize the general collaborative filtering technique, the data mining technique, etc.

For example, suppose that the following conditions are satisfied.

The client identifier associated client preference estimating factor information list received by the transmission of the client identifier associated client preference estimating factor information list from the client identifier associated client preference estimating factor information list provider server 1 to the recommended item presentation server 2 of the above described (2) is a list of item identifiers for each client identifier which are arranged in a descending order of the access dates and times according to the access logs (client identifier, item identifier, access date and time) of the item provider server 3;

The client preference estimating factor information map obtained by the recommended item presentation server 2 that received the client identifier associated client preference estimating factor information list by processing the received client identifier associated client preference estimating factor information list in order to be able to make a response to the recommended item presentation request from the client 6 is a list of item identifiers of items accessed by a client of each client identifier that is newly assigned uniquely within the recommended item presentation server 2 (which will be referred to as an item list for each client) and a list of client identifiers of clients who are accessing an item of each item identifier (which will be referred to as a client list for each item); and

The client preference estimating factor information received along with the recommended item presentation request is a list of “item identifiers”.

Then, the recommended item list can be produced by the following method.

<1> The extraction of a related client list;

All the client identifiers contained in the “client list for each item” are extracted for each item identifier in the list of “item identifiers” that is the client preference estimating factor information received along with the recommended item presentation request from the item provider server 3 at the recommended item presentation server 2. A list of the client identifiers extracted here will be referred to as a related client list.

<2> Narrowing down of a related client list;

A list of item identifiers contained in the “item list for each client” is extracted for each client identifier in the related client list extracted at <1>, the number of overlaps between the extracted item identifiers and the item identifiers in the list of “item identifiers” is counted for each client identifier in the related client list extracted at <1>, the client identifiers in the related client list are rearranged in a descending order of the number of overlaps, and a top N1 client identifiers from the rearranged client identifiers (where N1 is a positive integer) are set as a new related client list.

<3> The extraction of a related item list;

All the item identifiers contained in the “item list for each client” are extracted for each client identifier in the related client list. A list of the client identifiers extracted here will be referred to as a related item list.

<4> Narrowing down of a related item list;

A list of client identifiers contained in the “client list for each item” is extracted for each item identifier in the related item list extracted at <3>, the number of overlaps between the extracted client identifiers and the client identifiers in the related client list is counted for each item identifier in the related item list extracted at <3>, the item identifiers in the related item list are rearranged in a descending order of the number of overlaps, and a top N2 item identifiers from the rearranged item identifiers (where N2 is a positive integer) are set as a new related item list. This new related item list is then used as the recommended item list for the client who made the recommended item presentation request.

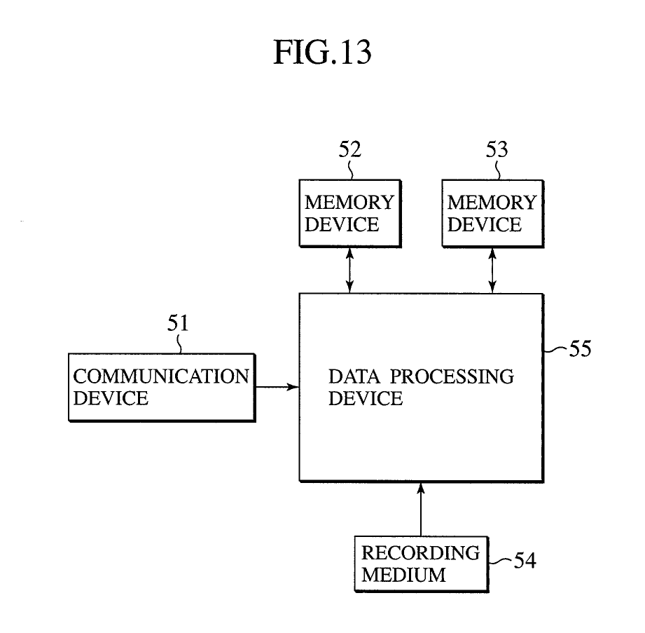

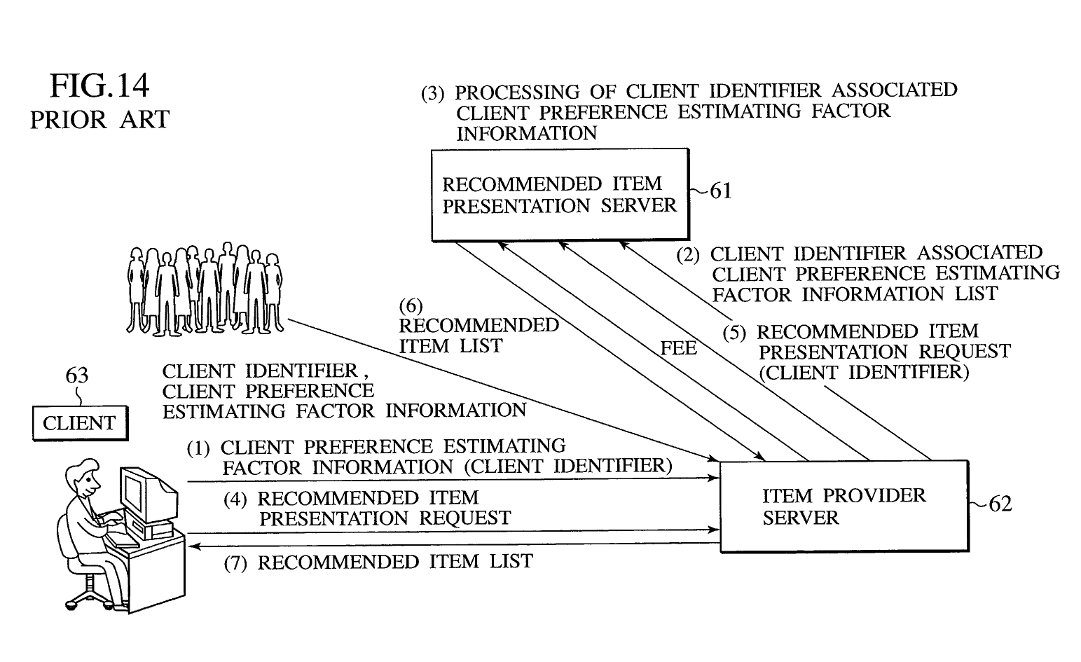

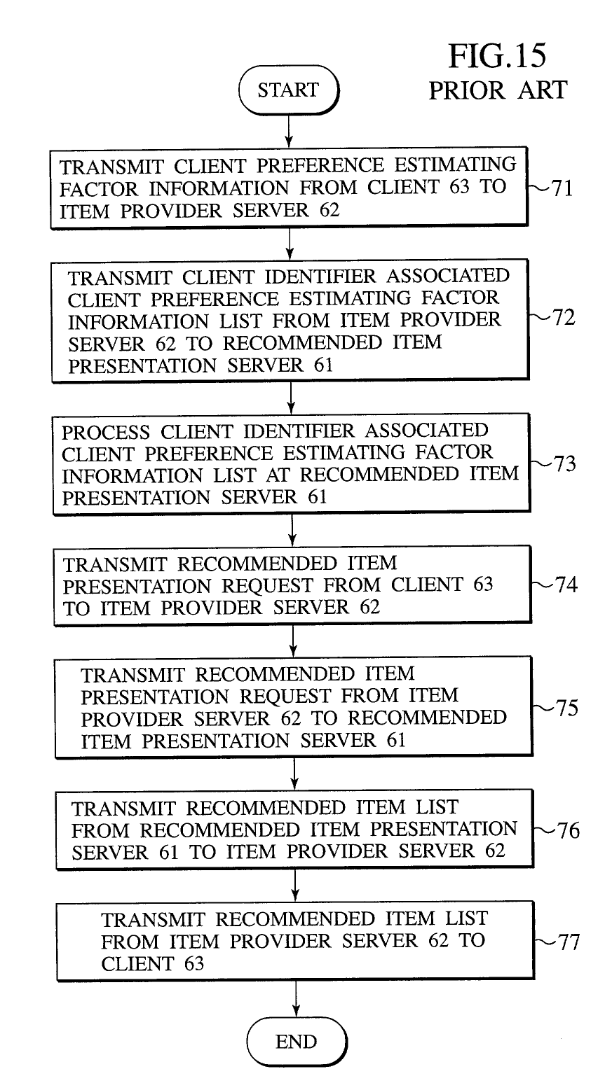

FIG. 13 shows an exemplary configuration of a computer system for implementing the recommended item presentation server 2 of FIG. 1. A communication device 51 carries out communications with the client identifier associated client preference estimating factor information list provider server 1 and the item provider server 3. A memory device 52 stores the client identifier associated client preference estimating factor information list and the client preference estimating factor information map. A memory device 53 is a hard disk device. A recording medium 54 is a floppy disk, CD-ROM, Magneto-optical disk or the like which records the recommended item presentation program for realizing the operations of the client preference estimating factor information list processing unit 4 and the recommended item presentation service unit 5 as described above. A data processing device 55 contains a CPU and interfaces for reading the recommended item presentation program from the recording medium 54 and executing this program.

It is to be noted that the present invention is expected to be particularly effective in the following business model.

For example, suppose that the recommended item presentation server of the present invention is operated by a large scale bookstore EC site (large site). The large site uses the access logs within its own site as the client preference estimating factor information, and maintains the client preference estimating factor information map.

On the other hand, suppose that there are other small scale bookstore EC sites (small sites), and each small site does not have its own recommended item presentation server or a sufficient amount of the access logs for producing the client preference estimating factor information map.

In this case, the large site can carry out the recommended item presentation service with respect to the small site group as follows.

(1) When there is a recommended item presentation request from a client at the small site, the small site extracts the client preference estimating factor information of this client from the access log within its own site, and sends it to the large site.

(2) The large site produces the recommended item list (book list) from the received client preference estimating factor information, and sends it to the small site.

(3) The small site that received the recommended item list returns the recommended item list to the client.

In this business model, the following merits can be expected.

Even the small site which does not or cannot have its own recommended item presentation server can provide the recommended item presentation service to its users.

The client preference estimating factor information to be sent to the large site is not identified as that of any specific client, so that the privacy can be protected.

The large site can provide the recommended item presentation service to the small sites and collect fees from them, without disclosing the client preference estimating factor information map which is the know-how of the large site.

As described above, in the present invention, the recommended item presentation service is provided to a plurality of item provider servers according to the client identifier associated client preference estimating factor information list provided from a third party company or the like so that the following effects can be achieved.

(1) The recommended item presentation service can be provided to clients utilizing the item provider servers without acquiring the client identifier associated client preference estimating factor information list from each item provider server that utilizes the recommended item presentation service.

(2) The client identifier is not required as information necessary in carrying out the recommended item presentation, so that there is no need to assign a client identifier for identifying the client which is unique over a plurality of item providing servers. Moreover, there is no possibility of leaking the client preference estimating factor information which is a privacy information of the client in correspondence with the client, so that it is possible to protect the privacy.

It is to be noted that the following variations are possible for the above described embodiment.

The network is not necessarily limited to the Internet. It can be a digital bidirectional TV, an IT home electronics network, etc.

The client can be a PC (Personal Computer), a portable telephone, a digital bidirectional TV set, an IT home electronics device, a word-processor capable of communications, a game device capable of communications, a clock capable of communications, a terminal capable of mobile communications such as PDA (Personal Digital Assistants), etc.

The input/output is not necessarily limited to Web pages. it is possible to utilize e-mails for the transmission of the access log, the recommended item presentation request, the client identifier, etc., as documents or titles of the e-mails. It is also possible to utilize the e-mail address instead of the client identifier. It is also possible to transmit the recommended item list as an e-mail document.

The client identifier can be managed in correspondence with a customer identifier different from the client identifier. The customer identifier can be a unique identifier entered arbitrarily at the client side, an ID assigned by the recommended item presentation device separately from the client identifier, etc.

The recommended item presentation can be realized in a form of a display superposed on a TV screen or a game display.

It is also to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the recommended item presentation server of the above described embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A recommended item presentation method, comprising the steps of:
(a) obtaining client identifier associated client preference estimating factor information of a plurality of clients which is information according to which a preference of each client is to be estimated; and
(b) receiving a recommended item presentation request and a client preference estimating factor information of one client from an item provider server for providing items to a plurality of clients through a network, where the client preference estimating factor information indicates a preference of the one client, without identifying the one client, producing a recommended item list according to the client identifier associated client preference estimating factor information and the client preference estimating factor information, and transmitting the recommended item list to the item provider server.

2. The recommended item presentation method of claim 1, wherein the step (a) obtains the client identifier associated client preference estimating factor information by receiving a client preference estimating factor information list from a client preference estimating factor information list providing server which collects the client identifier associated client preference estimating factor information from a plurality of clients.

3. The recommended item presentation method of claim 2, wherein the step (a) receives the client identifier associated client preference estimating factor information list in a form of a list of item identifiers of viewed/purchased items at the item provider server and dates and times of viewings/purchases of the viewed/purchased items for each client identifier, or a list of item identifiers of viewed/purchased items at the item provider server and ratings indicating levels of interest of each client with respect to the viewed/purchased items for each client identifier, or a list of item identifiers of interested items of each client for each client identifier.

4. The recommended item presentation method of claim 2, further comprising the step of paying a fee for transmission of the client identifier associated client preference estimating factor information list to the client preference estimating factor information list providing server.

5. The recommended item presentation method of claim 1, further comprising the step of receiving a fee for transmission of the recommended item list from the item provider server.

6. The recommended item presentation method of claim 1, wherein the step (a) also processes the client identifier associated client preference estimating factor information into a client preference estimating factor information map and the step (b) produces the recommended item list according to the client preference estimating factor information map and the client preference estimating factor information.

7. The recommended item presentation method of claim 6, wherein the step (a) produces the client preference estimating factor information map in a form of any of a list of item identifiers of accessed items of each client for each client identifier, a list of item identifiers of accessed items of each client and ratings indicating levels of interest of each client with respect to the accessed items for each client identifier, a list of client identifiers of accessing clients of each item for each item identifier, a list of client identifiers of accessing clients of each item and ratings indicating levels of interest of each client with respect to each item for each item identifier, and a list of correlation values among correlated items.

8. The recommended item presentation method of claim 6, wherein the step (b) produces the recommended item list by:
obtaining a related client list by extracting client identifiers contained in a list of client identifiers for each item that constitutes the client preference estimating factor information map, for each item identifier in a list of item identifiers that constitutes the client preference estimating factor information received along with the recommended item presentation request from the item provider server;
narrowing down the related client list by extracting item identifiers contained in a list of item identifiers for each client that constitutes the client preference estimating factor information map, for each client identifier in, the related client list, counting a number of overlaps between extracted item identifiers and item identifiers in the list of item identifiers that constitutes the client preference estimating factor information, for each client identifier in the related client list, rearranging client identifiers in the related client list in a descending order of counted number of overlaps, and setting a first prescribed number of client identifiers from a top of a rearranged related client list as a new related client list;
obtaining a related item list by extracting item identifiers contained in the list of item identifiers for each client, for each client identifier in the new related client list; and
narrowing down the related item list by extracting client identifiers contained in the list of client identifiers for each item, for each item identifier in the related item list, counting a number of overlaps between extracted client identifiers and client identifiers in the new related client list, for each item identifier in the related item list, rearranging item identifiers in the related item list in a descending order of counted number of overlaps, and setting a second prescribed number of item identifiers from a top of a rearranged related item list as the recommended item list.

9. A recommended item presentation server, comprising:
a client preference estimating factor information processing unit configured to obtain client identifier associated client preference estimating factor information of a plurality of clients which is information according to which a preference of each client is to be estimated; and
a recommended item presentation unit configured to receive a recommended item presentation request and a client preference estimating factor information of one client from an item provider server for providing items to a plurality of clients through a network, where the client preference estimating factor information indicates a preference of the one client, without identifying the one client, produce a recommended item list according to the client identifier associated client preference estimating factor information and the client preference estimating factor information, and transmit the recommended item list to the item provider server.

10. The recommended item presentation server of claim 9, wherein the client preference estimating factor information processing unit obtains the client identifier associated client preference estimating factor information by receiving a client preference estimating factor information list from a client preference estimating factor information list providing server which collects the client identifier associated client preference estimating factor information from a plurality of clients.

11. The recommended item presentation server of claim 10, wherein the client preference estimating factor information processing unit receives the client identifier associated client preference estimating factor information list in a form of a list of item identifiers of viewed/purchased items at the item provider server and dates and times of viewings/purchases of the viewed/purchased items for each client identifier, or a list of item identifiers of viewed/purchased items at the item provider server and ratings indicating levels of interest of each client with respect to the viewed/purchased items for each client identifier, or a list of item identifiers of interested items of each client for each client identifier.

12. The recommended item presentation server of claim 10, wherein the client preference estimating factor information processing unit also pays a fee for transmission of the client identifier associated client preference estimating factor information list to the client preference estimating factor information list providing server.

13. The recommended item presentation server of claim 9, wherein the recommended item presentation unit also receives a fee for transmission of the recommended item list from the item provider server.

14. The recommended item presentation server of claim 9, wherein the client preference estimating factor information processing unit also processes the client identifier associated client preference estimating factor information into a client preference estimating factor information map and the recommended item presentation unit produces the recommended item list according to the client preference estimating factor information map and the client preference estimating factor information.

15. The recommended item presentation server of claim 14, wherein the client preference estimating factor information processing unit produces the client preference estimating factor information map in a form of any of a list of item identifiers of accessed items of each client for each client identifier, a list of item identifiers of accessed items of each client and ratings indicating levels of interest of each client with respect to the accessed items for each client identifier, a list of client identifiers of accessing clients of each item for each item identifier, a list of client identifiers of accessing clients of each item and ratings indicating levels of interest of each client with respect to each item for each item identifier, and a list of correlation values among correlated items.

16. The recommended item presentation server of claim 14, wherein the recommended item presentation unit produces the recommended item list by:
obtaining a related client list by extracting client identifiers contained in a list of client identifiers for each item that constitutes the client preference estimating factor information map, for each item identifier in a list of item identifiers that constitutes the client preference estimating factor information received along with the recommended item presentation request from the item provider server;
narrowing down the related client list by extracting item identifiers contained in a list of item identifiers for each client that constitutes the client preference estimating factor information map, for each client identifier in the related client list, counting a number of overlaps between extracted item identifiers and item identifiers in the list of item identifiers that constitutes the client preference estimating factor information, for each client identifier in the related client list, rearranging client identifiers in the related client list in a descending order of counted number of overlaps, and setting a first prescribed number of client identifiers from a top of a rearranged related client list as a new related client list;
obtaining a related item list by extracting item identifiers contained in the list of item identifiers for each client, for each client identifier in the new related client list; and
narrowing down the related item list by extracting client identifiers contained in the list of client identifiers for each item, for each item identifier in the related item list, counting a number of overlaps between extracted client identifiers and client identifiers in the new related client list, for each item identifier in the related item list, rearranging item identifiers in the related item list in a descending order of counted number of overlaps, and setting a second prescribed number of item identifiers from a top of a rearranged related item list as the recommended item list.

17. A computer usable medium having computer readable program codes embodied therein for causing a computer to function as a recommended item presentation server, the computer readable program codes include:
a first computer readable program code for causing said computer to obtain client identifier associated client preference estimating factor information of a plurality of clients which is information according to which a preference of each client is to be estimated; and
a second computer readable program code for causing said computer to receive a recommended item presentation request and a client preference estimating factor information of one client from an item provider server for providing items to a plurality of clients through a network, where the client preference estimating factor information indicates a preference of the one client, without identifying the one client, produce a recommended item list according to the client identifier associated client preference estimating factor information and the client preference estimating factor information, and transmit the recommended item list to the item provider server.

18. A method for providing a recommended item presentation service from a recommended item presentation server associated with one item provider server to a plurality of item provider servers for providing items to a plurality of clients through a network, comprising the steps of:
(a) obtaining client identifier associated client preference estimating factor information of a plurality of clients which is information according to which a preference of each client is to be estimated, at the recommended item presentation server; and
(b) upon receiving a recommended item presentation request and a client preference estimating factor information of one client from one of the plurality of item provider servers, where the client preference estimating factor information indicates a preference of the one client, without identifying the one client, producing a recommended item list according to the client identifier associated client preference estimating factor information and the client preference estimating factor information and transmitting the recommended item list to the one of the plurality of item provider servers at the recommended item presentation server.
